(19) United States
(12) Patent Application Publication
(10) Pub. No.: US 2016/0148553 A1
(43) Pub. Date: May 26, 2016

(54) Display Apparatus

(71) Applicant: SAKAI DISPLAY PRODUCTS CORPORATION, Osaka (JP)

(72) Inventor: Yamakawa Ryo, Sakai-shi, Osaka (JP)

(21) Appl. No.: 14/898,687

(22) PCT Filed: Jun. 10, 2014
(86) PCT No.: PCT/JP2014/065357

§ 371 Date: Dec. 15, 2015

(30) Foreign Application Priority Data
Jun. 18, 2013 (JP) 2013-127685

(51) Int. Cl. G09G 3/20; G09G 3/36

(52) U.S. Cl. CPC G09G 3/2003; G09G 3/36; G09G 2320/0673

(57) ABSTRACT

A display apparatus displays any one of a first color image in which a first image processing using first image processing data is executed, and a second color image in which a second image processing using second image processing data is executed thereon. When the second color image is being displayed, an intensity of one color light emitted by the display apparatus is more decreased than the case of displaying the first color image. The reason is that, according to the second image processing, a gradation value of the one color is smaller than that in the case of using the first image processing. Furthermore, the image quality of the second color image is not deteriorated to a greater extent than the image quality of the first color image. The reason is that, according to the second image processing, the one color light is weakened by adjusting the gradation value of the one color, while deterioration in the image quality is also suppressed by adjusting the gradation values of the other colors.

### CROSS-REFERENCE TO RELATED APPLICATIONS

This application is the national phase under 35 U. S. C. §371 of PCT International Application No. PCT/JP2014/065357 which has an International filing date of Jun. 10, 2014 and designated the United States of America.

### FIELD

The present invention relates to a display apparatus which displays a color image.

### BACKGROUND

Conventionally, a display apparatus which includes a liquid crystal panel and a backlight, and is configured to automatically adjust light emission luminance of the backlight has been proposed (see Japanese Patent Laid-open Publication No. 2010-68260, which is hereinafter referred to as Patent Document 1).

The display apparatus (an “image display apparatus” in the text) described in Patent Document 1 has a plurality of setting values of light emission luminance of the backlight set therein. The setting value is appropriately selected according to the brightness of a room. For example, when the room is dark, a setting value suitable to a bedroom environment during nighttime is selected. As a result, the display apparatus described in Patent Document 1 displays a color image having an image quality according to human luminosity factor characteristics thereon.

Recently, reducing the intensity of blue light emitted by the display apparatus (so-called blue-light blocking) has been introduced. This is because the blue light made incident on eyes of a user from the display apparatus is said to cause eyestrain, eye fatigue or the like.

As a blue-light blocking method, there are a method of mounting a sheet for blue-light blocking on the display apparatus, a method that the user wears glasses for blue-light blocking or the like. These are methods of weakening the blue light made incident on the eyes of the user, without changing the intensity of the blue light emitted by the display apparatus.

Alternatively, there is a method of manually changing the setting of the blue light in the display apparatus by the user. This is a method of weakening the blue light made incident on the eyes of the user by reducing the intensity of the blue light emitted by the display apparatus.

### SUMMARY

However, the methods using the sheet, glasses or the like have a drawback in that it is necessary to prepare the sheet or the glasses in addition to the display apparatus. That is, the cost burden on the user is large. Further, mounting the sheet or wearing the glasses requires labor and time, which is inconvenient for the user.

Meanwhile, the method of manually changing the setting of the blue light has an advantage in that the cost burden on the user does not occur. Nonetheless, this method has a drawback in that the user need to adjust the intensity of the blue light to an appropriate level by operating the display apparatus. This may also be inconvenient for the user.

Furthermore, only by simply weakening the blue light, the image quality may be unnecessarily deteriorated (for example, the color image is unnecessarily tinged with yellow).

Patent Document 1 describes that the light emission luminance of the backlight is automatically reduced when the room is dark. If the light emission luminance of the backlight is low, the blue light is weakened. However, the display apparatus described in Patent Document 1 does not reduce the light emission luminance of the backlight when the room is bright. Briefly, when the room is bright, it is not possible to weaken the blue light. In addition, reducing the light emission luminance of the backlight uniformly weakens not only the blue light, but also red light and green light. Accordingly, if the light emission luminance of the backlight is reduced when the room is bright, a dark color image is unnecessarily displayed.

In consideration of the above-mentioned circumstances, it is an object of the present invention to provide a display apparatus which is capable of automatically weakening one color light while suppressing the deterioration in image quality of a color image.

A display apparatus according to the present invention comprises a storage part configured to store a plurality of types of image processing data to be used when executing an image processing on a color image in which each color is represented by a gradation value, a selection part configured to select one type of image processing data from the plurality of types of image processing data stored in the storage part and an image processing part configured to execute the image processing using the image processing data selected by the selection part on the color image. In the display apparatus, the color image in which the image processing is executed by the image processing part is displayed on the display apparatus.

In the display apparatus, the storage part stores first image processing data configured to adjust the gradation values of one color and the other colors, and second image processing data configured to adjust the gradation value of the one color to be smaller than a gradation value in a case of adjusting using the first image processing data, and adjust the gradation value of other colors so that a chromaticity obtained from the gradation value after adjustment of each of the one color and the other colors satisfies a prescribed condition.

In the display apparatus according to the present invention, the prescribed condition may include a condition in which, within a range from a first prescribed gradation value or more which is a minimum value or more of the gradation value before adjustment to a second prescribed gradation value or less which is a maximum value or less of the gradation value before adjustment, the gradation value before adjustment and the chromaticity follow a prescribed function.

In the display apparatus according to the present invention, in relation to the gradation value of the one color, the gradation value after adjustment using the second image processing data may be equal to a value obtained by reducing the gradation value after adjustment using the first image processing data in a prescribed procedure.

In the display apparatus according to the present invention, each of the first and second image processing data may be stored in a lookup table to be used upon a gamma-correction processing.

In the display apparatus according to the present invention, the one color may be a blue color, and the other colors may be a red color and a green color.

According to an aspect of the present invention, in accordance with a selection by the selection part, any one of a color image in which image processing using the first image processing data is executed (hereinafter, referred to as the first color image in which the first image processing is executed), and a color image in which image processing using the second image processing data is executed (hereinafter, referred to as the second color image in which the second image processing is executed) is displayed. When the second color image is being displayed, an intensity of one color light emitted by the display apparatus is more decreased than the case of displaying the first color image. The reason is that, according to the second image processing, the gradation value of the one color is smaller than the case of using the first image processing.

Furthermore, the image quality of the second color image is not deteriorated to a greater extent than the image quality of the first color image. The reason is that, according to the second image processing, the one color light is weakened by adjusting the gradation value of the one color, while deterioration in the image quality is also suppressed by adjusting the gradation value of the other colors. In this case, the chromaticity obtained from the gradation value after adjustment of each of the one color and the other colors satisfies a prescribed condition.

The second image processing is executed by the image processing part. Therefore, it is not necessary for the user to manually decrease the gradation value of the one color.

According to another aspect of the present invention, the gradation value before adjustment and the chromaticity obtained from the gradation value after adjustment follow a prescribed function. In this case, the chromaticity of each pixel included in the first color image and the chromaticity of each pixel included in the second color image are suppressed from being greatly different from each other. That is, both of weakening the one color light and suppressing the deterioration in the image quality are satisfied.

However, the prescribed function is applied within a range in which the gradation value before adjustment is the first gradation value or more, and the second gradation value or less.

For example, in the case where the first prescribed gradation value is equal to a minimum value of the gradation value before adjustment and the second prescribed gradation value is equal to a maximum value of the gradation value before adjustment, the prescribed function over an entire area of the gradation value before adjustment is uniformly used. Accordingly, in all the pixels included in the color image after adjustment, both of weakening the one color light and suppressing the deterioration in the image quality may be satisfied.

Meanwhile, in the case where the first prescribed gradation value is larger than the minimum value of the gradation value before adjustment, if the gradation value before adjustment is less than the first prescribed gradation value, the prescribed function is not applied thereto. It is conceivable that, in the color image before adjustment, one color light of a pixel having a gradation value of one color which is less than the first prescribed gradation value is weaker than a pixel with no such gradation value. Therefore, for this pixel, in the color image after adjustment, both of weakening the one color light and suppressing the deterioration in the image quality may be satisfied, or suppressing the deterioration in the image quality may be prioritized.

In addition, in the case where the second prescribed gradation value is smaller than the maximum value of the gradation value before adjustment, if the gradation value before adjustment exceeds the second prescribed gradation value, the prescribed function is not applied thereto. It is conceivable that, in the color image before adjustment, one color light of a pixel having a gradation value of one color which exceeds the second prescribed gradation value is stronger than a pixel with no such gradation value. Therefore, for this pixel, in the color image after adjustment, both of weakening the one color light and suppressing the deterioration in the image quality may be satisfied, or weakening the one color light may be prioritized.

According to another aspect of the present invention, the gradation value of the one color after adjustment relating to the second image processing is equal to a value obtained by reducing the gradation value of the one color after adjustment relating to the first image processing with a prescribed procedure (for example, a value obtained by reducing a prescribed value from the gradation value of the one color, or a value obtained by reducing the gradation value of the one color by a prescribed rate). Accordingly, the gradation value of the one color after adjustment relating to the second image processing may be easily obtained from the gradation value of the one color after adjustment relating to the first image processing.

According to another aspect of the present invention, an image processing for weakening the one color light while suppressing the deterioration in the image quality (hereinafter, referred to as light reduction processing), and the gamma-correction processing may be simultaneously executed on the color image. In other words, it is not necessary to execute the light reduction processing, aside from the image processing conventionally executed in the art.

As a result, for example, effects such as a shortening in a calculation time and a reduction in a calculation amount due to using both of a calculation for the light reduction processing and a calculation for the gamma-correction processing, or a saving in a storage capacity of the storage part due to using both of the image processing data to be used upon the light reduction processing and data of the lookup table to be used upon the gamma-correction processing (hereinafter, referred to as a gamma table) may be exhibited.

According to another aspect of the present invention, in the color image having common RGB three colors, it is possible to achieve automatic blue-light blocking without using the sheet, glasses or the like for blue-light blocking. Therefore, it is possible to improve the convenience for the user.

When using the display apparatus of the present invention, it is possible to weaken the one color light, and suppress the deterioration in the image quality.

In addition, it is not necessary to prepare the sheet or the glasses for blue-light blocking in addition to the display apparatus, so that the cost burden on the user may be suppressed.

Further, labor and time for mounting the sheet or wearing the glasses do not occur, while it is also not necessary for the user to adjust the intensity of the one color light to an appropriate level by operating the display apparatus. Briefly, it is possible to improve the convenience for the user.

The above and further objects and features will more fully be apparent from the following detailed description with accompanying drawings.

### BRIEF DESCRIPTION OF THE DRAWINGS

FIG. 1 is a block diagram illustrating an electrical functional configuration of a display apparatus according to Embodiment 1 of the present invention.

FIG. 2 is a graph illustrating CT characteristic curves in the case of not performing blue-light blocking in the display apparatus according to Embodiment 1 of the present invention.

FIG. 3 is a graph illustrating the CT characteristic curves in the case of performing the blue-light blocking only by simply weakening the blue light.

FIG. 4 is a graph illustrating the CT characteristic curves in the case of performing the blue-light blocking in the display apparatus according to Embodiment 1 of the present invention.

FIG. 5 is a graph illustrating the CT characteristic curves in the case of performing the blue-light blocking in a display apparatus according to Embodiment 2 of the present invention.

FIG. 6 is a graph illustrating the CT characteristic curves in the case of performing the blue-light blocking in a display apparatus according to Embodiment 3 of the present invention.

### DETAILED DESCRIPTION

Hereinafter, the present invention will be described in detail with reference to the drawings illustrating embodiments thereof.

### Embodiment 1

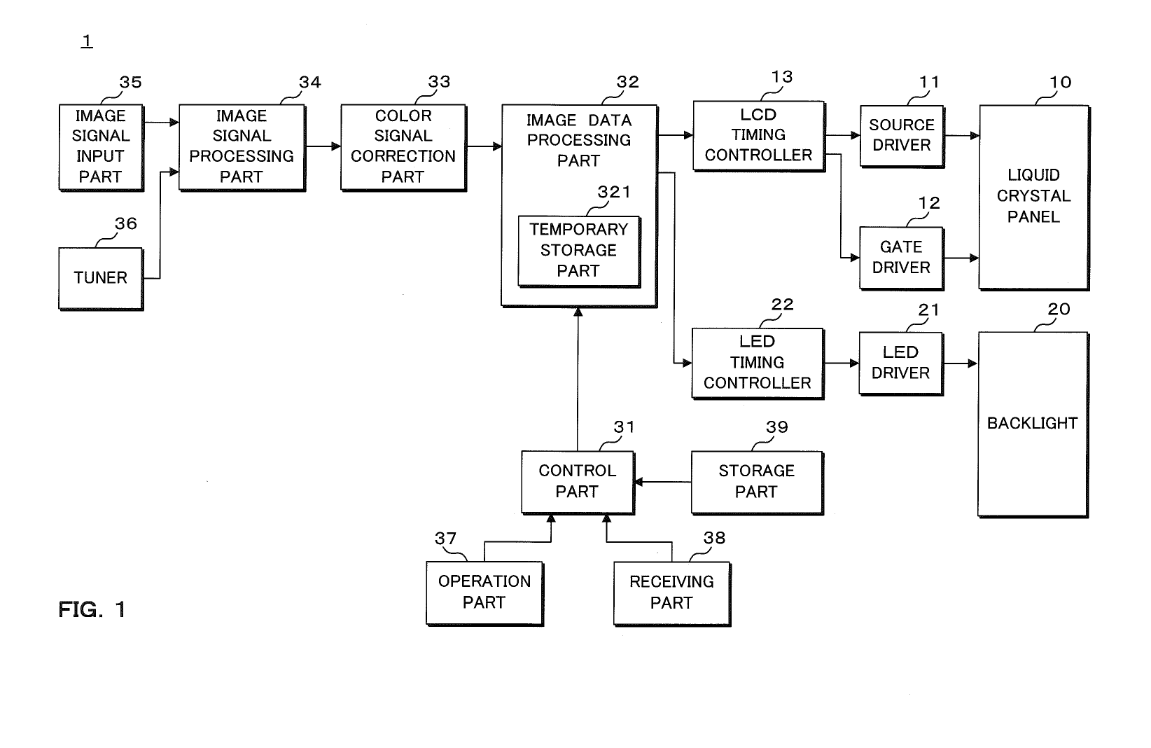

FIG. 1 is a block diagram illustrating an electrical functional construction of a display apparatus 1 according to Embodiment 1 of the present invention. The display apparatus 1 is used as a television receiver or a display. In the display apparatus 1, a display of a first color image and a display of a second color image are selectively executed, which will be described below. The display of the first color image is a normal display in which blue light is not blocked. The display of the second color image is a display in which the blue light is blocked.

The display apparatus 1 includes a rectangular liquid crystal panel 10 and a direct type backlight 20. The backlight 20 illuminates the liquid crystal panel 10 from a back side. The backlight 20 is formed by arranging a plurality of LEDs in a matrix shape. Further, the backlight 20 is not limited to the direct type. In addition, the backlight 20 may have a configuration in which a light source other than the LEDs (for example, optical fibers) is used. The liquid crystal panel 10 includes liquid crystal and a color filter, which are not illustrated. Light emitted by the backlight 20 is transmitted through the liquid crystal of the liquid crystal panel 10, then is transmitted through the color filter, and thereby the light is emitted to the outside with being converted into red light, green light, or blue light.

Further, the display apparatus 1 includes a source driver 11, a gate driver 12, an LCD timing controller 13, an LED driver 21, and an LED timing controller 22. Furthermore, the display apparatus 1 includes a control part 31, an image data processing part 32, a color signal correction part 33, an image signal processing part 34, an image signal input part 35, a tuner 36, an operation part 37, a receiving part 38, and a storage part 39. The storage part 39 previously stores a plurality of types of image processing data. Specifically, the storage part 39 stores first image processing data for displaying the first color image and second image processing data for displaying the second color image.

In the present embodiment, the first image processing data is stored in one gamma table common to RGB three colors (hereinafter, referred to as a first gamma table). The data of the first gamma table is obtained, for example, by a conventional method for a prescribed y (for example, y is 2.2). Meanwhile, the second image processing data is stored in three gamma tables respectively corresponding to the RGB three colors one to one. Hereinafter, the three gamma tables are collectively referred to as a second gamma table. In addition, a gamma table to be used upon gamma-correcting a gradation value of a red color is referred to as a red gamma table. Similarly, the gamma tables corresponding to a green color and a blue color are referred to as a green gamma table and blue gamma table, respectively.

Output values of the gradation values corresponding to each input gradation value (hereinafter, referred to as output gradation values) are previously stored in each gamma table between a minimum value “0” and a maximum value “255” of the input values of the gradation values (hereinafter, referred to as input gradation values). The input gradation value and the output gradation value in the first gamma table are the first image processing data, and the input gradation value and the output gradation value in the second gamma table are the second image processing data.

All the input gradation values stored in each gamma table are the same as each other. Hereinafter, the input gradation value in each gamma table is referred to as an input gradation value V[i]. Herein, an index i is an integer of 0, 1, 2, . . . and 255, and V[i] is i.

In addition, the output gradation value in the first gamma table is referred to as a first output gradation value W[i].

Further, the output gradation value in the red gamma table is referred to as a second output gradation value R[i]. Similarly, the output gradation values in the green gamma table and the blue gamma table are referred to as a second output gradation value G[i] and a second output gradation value B[i], respectively.

First, the first gamma table will be described.

The first output gradation value W[i] is obtained by setting results calculated using Equation (1) below to be an integer value. Herein, a constant p is the inverse number of Y. The first output gradation value W[i] has a relationship of 0≦W[i]≦255.

W[i]=255×(V[i]/255)^{P} (1)

Next, the blue gamma table will be described.

The second output gradation value B[i] is obtained by setting the results calculated using Equation (2) below to be an integer value. Upon calculation of Equation (2), the first output gradation value W[i] is known by Equation (1). A prescribed ratio A1 is a given constant as described below. The second output gradation value B[i] has a relationship of 0≦B[i]≦{255×(A1/100)}.

B[i]=W[i]×(A1/100) (2)

The prescribed ratio A1 is any value having a relationship of 0<A1<100 (unit is [%]). As the prescribed ratio A1 is decreased, the second output gradation value B[i] is smaller than the first output gradation value W[i]. Therefore, as the prescribed ratio A1 is decreased, the blue light is weakened. In the present embodiment, the prescribed ratio A1 is 80%. Accordingly, the second output gradation value B[i] is uniformly reduced to 80% of the first output gradation value W[i].

As a result, when a color image in which a gamma-correction processing is executed using the second gamma table (that is, the second color image) is displayed, the intensity of the blue light is reduced, compared to when the color image in which the gamma-correction processing is executed using the first gamma table (that is, the first color image) is displayed. In other words, the blue-light blocking is achieved.

Next, the red gamma table and the green gamma table will be described.

In relation to the red gamma table and the green gamma table, the second output gradation values R[i] and G[i] are calculated so that chromaticity x[i] and y[i] calculated from the second output gradation values R[i], G[i] and B[i] satisfy a prescribed condition, and each of the second output gradation values R[i] and G[i] are set to be an integer value. Details of the calculation of the second output gradation values R[i] and G[i] will be described below.

The operation part 37 has a switch, a button or the like to be operated by the user. The operation part 37 inputs a signal according to the operation conditions of the switch, the button or the like to the control part 31.

The receiving part 38 receives a control signal from a remote controller (not illustrated). The receiving part 38 inputs a signal according to the received control signal to the control part 31.

When the user operates the operation part 37 or the remote controller, information indicating whether the blue-light blocking is required is supplied to the display apparatus 1.

The control part 31 controls the operation of each part of the display apparatus 1. When the signal input from the operation part 37 or the receiving part 38 indicates whether the blue-light blocking is required, the control part 31 in the present embodiment selects any one of the first gamma table and second gamma table stored in the storage part 39. In more detail, when the blue-light blocking is not required, the control part 31 selects the first gamma table. When the blue-light blocking is required, the control part 31 selects the second gamma table.

The control part 31 reads out the selected gamma table from the storage part 39, and writes the read gamma table in a temporary storage part 321 to be described below. The control part 31 writes necessity information indicating whether the blue-light blocking is required in the temporary storage part 321.

The above-described control part 31 functions as a selection part in the embodiment of the present invention.

In the image signal input part 35, an image signal indicating a color image including a plurality of pixels is input from the outside. The image signal includes information indicating the gradation value of the red color, the gradation value of the green color, and the gradation value of the blue color in each pixel.

The tuner 36 receives a broadcast wave of a television to generate an image signal. Further, the display apparatus 1 may not include the tuner 36.

The image signal input to the image signal input part 35 or the image signal generated by the tuner 36 is input to the image signal processing part 34.

The image signal processing part 34 executes signal processing such as a conversion of an image size or superposition of characters on the input image signal. The image signal for which the signal processing is executed by the image signal processing part 34 is input to the color signal correction part 33.

The color signal correction part 33 executes an image quality adjustment processing for adjusting the image quality such as an adjustment of chroma, or an adjustment of sharpness on the input image signal. The image signal for which the image quality adjustment processing is executed by the color signal correction part 33 is input to the image data processing part 32.

The image data processing part 32 has the temporary storage part 321. The image data processing part 32 executes the gamma-correction processing on the input image signal. In this case, the image data processing part 32 uses the gamma table written in the temporary storage part 321. Briefly, the image data processing part 32 uses the gamma table which is selected by the control part 31.

However, when the necessity information indicating that the blue-light blocking is not required is written in the temporary storage part 321, the image data processing part 32 applies the gamma table (that is, the first gamma table) written in the temporary storage part 321 to all the gradation values of RGB three colors.

Meanwhile, when the necessity information indicating that the blue-light blocking is required is written in the temporary storage part 321, the image data processing part 32 applies the gamma table (that is, the second gamma table) written in the temporary storage part 321. In more detail, the image data processing part 32 applies the red gamma table to the gradation value of the red color. Similarly, the image data processing part 32 applies the green gamma table (or the blue gamma table) to the gradation value of the green color (or the gradation value of the blue color).

The above-described image data processing part 32 functions as an image processing part in the embodiment of the present invention.

The image data processing part 32 generates display data for operating the liquid crystal panel 10 from the image signal after the gamma-correction processing. In addition, the image data processing part 32 generates lighting data for operating the backlight 20 from the image signal. The display data generated by the image data processing part 32 is input to the LCD timing controller 13. The lighting data generated by the image data processing part 32 is input to the LED timing controller 22.

The LCD timing controller 13 generates a timing signal indicating a timing for driving the liquid crystal based on the input display data. The timing signal generated by the LCD timing controller 13 is input to the source driver 11 and the gate driver 12.

The source driver 11 and the gate driver 12 drive the liquid crystal of the liquid crystal panel 10 according to the input timing signal.

The LED timing controller 22 generates a timing signal indicating a timing for driving the LEDs based on the input lighting data. The timing signal generated by the LED timing controller 22 is input to the LED driver 21.

The LED driver 21 drives the LEDs of the backlight 20 according to the input timing signal.

As a result of the above, the display apparatus 1 displays any one of the first color image and second color image.

Next, a relationship between the second output gradation values R[i], G[i], B[i] and the chromaticity x[i], y[i] will be described.

By converting an RGB color system into an XYZ color system, the relationship between the second output gradation values R[i], G[i], B[i] and the gradation values X[i], Y[i], Z[i] is represented by the following Equations (3-1) to (3-3).

X[i]=αr×R[i]+αg×G[i]+αb×B[i] (3-1)

Y[i]=βr×R[i]+βg×G[i]+βb×B[i] (3-2)

Z[i]=δr×R[i]+δg×G[i]+δb×B[i] (3-3)

where each of αr, αg, αb, βr, βg, βb, δr, δg and δb is a prescribed constant. For example, αr, αg, αb, βr, βg, βb, δr, δg and δb are 0.41, 0.36, 0.18, 0.21, 0.72, 0.07, 0.02, 0.12 and 0.95.

Hereinafter, Equations (3-1), (3-2) and (3-3) are collectively referred to as Equation (3).

By converting the XYZ color system into an xy color system, the relationship between the gradation values X[i], Y[i], Z[i] and the chromaticity x[i], y[i] is represented by the following Equations (4-1) and (4-2).

x[i]=X[i]/{X[i]+Y[i]+Z[i]} (4-1)

y[i]=Y[i]/{X[i]+Y[i]+Z[i]} (4-2)

Hereinafter, Equations (4-1) and (4-2) are collectively referred to as Equation (4).

If the second output gradation values R[i], G[i] and B[i] are known, the chromaticity x[i] and y[i] calculated from the second output gradation values R[i], G[i] and B[i] are obtained by substituting Equation (3) into Equation (4). The chromaticity x[i] and y[i] are the chromaticity x[i] and y[i] when performing the blue-light blocking while suppressing deterioration in the image quality.

Similarly, the chromaticity x[i] and y[i] calculated from the first output gradation value W[i] of each of the RGB three colors are obtained by substituting the following Equations (3-4) to (3-6) into Equation (4). The chromaticity x[i] and y[i] are the chromaticity x[i] and y[i] when not performing the blue-light blocking.

X[i]=αr×W[i]+αg×W[i]+αb×W[i] (3-4)

Y[i]=βr×W[i]+βg×W[i]+βb×W[i] (3-5)

Z[i]=δr×W[i]+δg×W[i]+δb×[i] (3-6)

Next, a CT characteristic curve will be described.

The CT characteristic curve illustrates the relationship between the input gradation value V[i] and the chromaticity x[i] and y[i] calculated from the various output gradation values. Seeing the CT characteristic curve, it is possible to estimate a superiority of the image quality of the color image after the gamma-correction processing is executed.

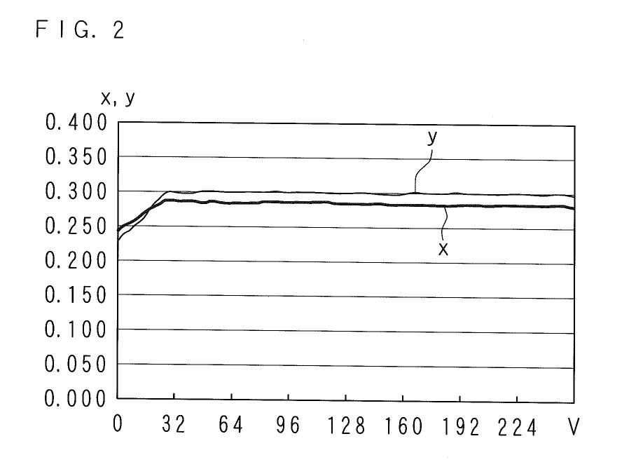

FIG. 2 is a graph illustrating the CT characteristic curves in the case of not performing the blue-light blocking in the display apparatus 1.

The horizontal axis of the graph illustrated in FIG. 2 is the input gradation value V[i] (“V” in the drawings) of each of the RGB three colors.

The vertical axis of the graph illustrated in FIG. 2 is the chromaticity x[i] and [i] (“x” and “y” in the drawings) obtained from the first output gradation value W[i] of each of the RGB three colors.

As illustrated in FIG. 2, within a range in which the input gradation value V[i] is “0” to “32”, both of the chromaticity x[i] and y[i] are linearly increased. When the input gradation value V[i] is within a range of “32” to “255,” both of the chromaticity x[i] and y[i] are substantially constant.

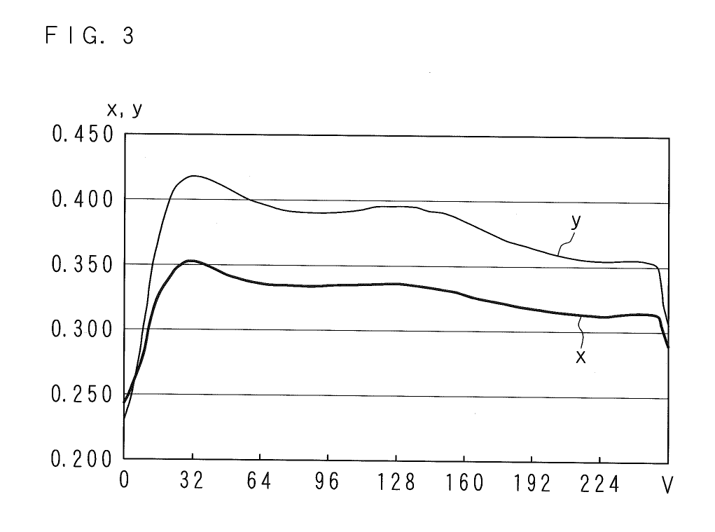

Such CT characteristic curves have no inflection point as those included in the CT characteristic curves illustrated in FIG. 3 to be described below (hereinafter, referred to as that the CT characteristic curves are smooth). Therefore, the first color image is high-quality.

FIG. 3 is a graph illustrating the CT characteristic curves in the case of performing the blue-light blocking only by simply weakening the blue light.

Herein, performing the blue-light blocking only by simply weakening the blue light means the case in which the blue gamma table is applied to the gradation value of the blue color, whereas the first gamma table is applied to the respective gradation values of the red and green colors. Accordingly, when performing the blue-light blocking only by simply weakening the blue light, the chromaticity x[i] and y[i] are obtained by substituting the following Equations (3-7) to (3-9) into Equation (4).

X[i]=αr×W[i]+αg×W[i]+αb×B[i] (3-7)

Y[i]=βr×W[i]+β×W[i]+βb×B[i] (3-8)

Z[i]=δr×W[i]+δg×W[i]+δb×B[i] (3-9)

As illustrated in FIG. 3, within the range in which the input gradation value V[i] is “0” to “32,” both of the chromaticity x[i] and y[i] are increased like an upward protruding quadratic function. That is, the CT characteristic curves are smooth.

However, within a range in which the input gradation value V[i] is “32” to “255,” the CT characteristic curves have a plurality of inflection points, and in the vicinity of the inflection points, a change in the chromaticity x[i] and y[i] for an increase or decrease of the input gradation value V[i] is large (which means that “the vicinity of the inflection points is steep”).

This shows that the image quality of the color image in which the gamma-correction processing is executed may be deteriorated.

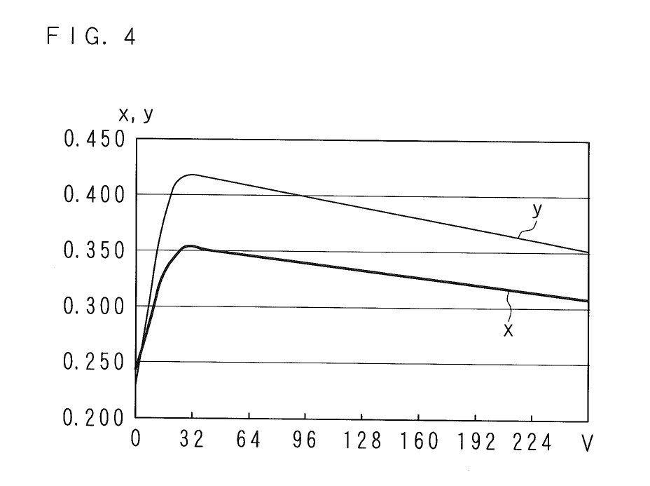

FIG. 4 is a graph illustrating the CT characteristic curves in the case of performing the blue-light blocking in the display apparatus 1 according to Embodiment 1.

The CT characteristic curves illustrated in FIG. 4 are identical to the CT characteristic curves illustrated in FIG. 3, within the range in which the input gradation values V[i] of the RGB three colors are “0” to “32”.

Meanwhile, within the range in which the input gradation values V[i] of the RGB three colors are “32” to “255,” the CT characteristic curves illustrated in FIG. 4 are obtained by linearly approximating the CT characteristic curves illustrated in FIG. 3.

In this case, the chromaticity x[i] and y[i] in the range of 32≦V[i]≦255 are represented by the following Equations (5-1) and (5-2).

x[i]={(0.282−x1)/223}×V[i]+1.14×x1−0.04 (5-1)

y[i]={(0.288−y1)/223}×V[i]+1.14×y1−0.09 (5-2)

where constants x1 and y1 are equal to the chromaticity x[32] and y[32] in the CT characteristic curves illustrated in FIG. 3.

Hereinafter, Equations (5-1) and (5-2) are collectively referred to as Equation (5). If the input gradation value V[255] is substituted into Equation (5), equations of x[255]=0.282 and Y[255]=0.288 is satisfied.

Next, a procedure for obtaining the second output gradation values R[i] and G[i] of the red gamma table and the green gamma table will be described.

In the present embodiment, within a range from a first prescribed gradation value or more which is greater than the minimum value of the input gradation value V[i], to a second prescribed graduation value or less which is equal to the maximum value of the input gradation value V[i], the input gradation value V[i] and the chromaticity obtained from the second output gradation values R[i], G[i] and B[i] follow a prescribed function.

First, the case within the range of less than the first prescribed gradation value will be described.

Within a range of 0≦V[i]<32, an equation of R[i]=G[i]=W[i] is satisfied. Briefly, each of the second output gradation values R[i] and G[i] within the range of 0≦V[i]<32 in the red gamma table and the green gamma table is easily obtained, by copying the first output gradation value W[i] in the first gamma table.

Next, the case within the range of the first prescribed gradation value or more, and the second prescribed graduation value or less will be described.

Within the range of 32≦V[i]≦255, the second output gradation values R[i] and G[i] are calculated so that the chromaticity x[i] and y[i] calculated from the second output gradation values R[i], G[i] and B[i] follow Equation (5). Upon this calculation, since the second output gradation value B[i] and the chromaticity x[i] and y[i] are known, when solving Equations (3), (4) and (5) with respect to the second output gradation values R[i] and G[i], and setting the obtained results to be an integer value, the second output gradation values R[i] and G[i] are obtained.

When executing the gamma-correction processing using the second gamma table obtained as described above, the CT characteristic curves are smooth as illustrated in FIG. 4. Therefore, the second color image is high-quality.

When using the display apparatus 1 as described above, a user who requires the blue-light blocking operates the operation part 37 or the remote controller, to select an icon indicating that the blue-light blocking is executed from a menu screen (not illustrated), for example. As a result, it is possible to display the second color image with the blue light being blocked on the display apparatus 1 without manually reducing the intensity of the blue light.

Similarly, a user who does not require the blue-light blocking operates the operation part 37 or the remote controller, to cancel the selection of the icon indicating that the blue-light blocking is executed on the menu screen (not illustrated) for example. As a result, it is possible to display the first color image with the blue light not being blocked on the display apparatus 1.

Accordingly, it is not necessary for the user to prepare the sheet, glasses or the like for blue-light blocking. In addition, it is not necessary to attach and detach the sheet, glasses or the like according to whether the blue-light blocking is required.

As a result of the above, the convenience for the user is high. Further, the cost burden on the user is small by as much as that the sheet, glasses or the like for blue-light blocking is not required.

Further, the display apparatus 1 may not have the configuration in which the color image is displayed using the liquid crystal panel 10 and the backlight 20 including the color filter. For example, the display apparatus 1 may have a configuration in which the color image is displayed using an LED display or an organic EL display.

The display apparatus 1 of the present embodiment includes the control part 31, the image data processing part 32, the color signal correction part 33, and the image signal processing part 34, each of which is individually independent hardware. However, the configuration of the display apparatus 1 is not limited thereto. For example, the display apparatus 1 may have a configuration in which the processing to be executed by the control part 31, the image data processing part 32, the color signal correction part 33, and the image signal processing part 34 are executed by software processing in a digital signal processor (DSP). In addition, the display apparatus 1 may have a configuration which includes a hardware having a combination of functions of the control part 31, the image data processing part 32, the color signal correction part 33, and the image signal processing part 34.

In this regard, the storage part 39 may store a plurality of types of second gamma tables. For example, the storage part 39 may store second gamma tables having prescribed ratios A1 different from each other. In this case, a degree of reducing the blue light is provided to the display apparatus 1 by the user using the operation part 37 or the remote controller 38. As the degree of reducing the blue light is increased, the second gamma table including a small prescribed ratio A1 is selected.

In addition, the storage part 39 may store the first gamma table and second gamma table corresponding to each of a plurality of types of Y (for example, Y=1.8 and 2.2).

In any case, the control part 31 selects an appropriate first gamma table or second gamma table according to a request of the user such as the necessity of blue-light blocking, or the degree of reducing the blue light, and applies the selected gamma table to the image data processing part 32.

The display apparatus 1 of the present embodiment has the configuration in which the control part 31 writes the first gamma table or second gamma table into the temporary storage part 321 of the image data processing part 32, but it is not limited thereto. For example, it may be configured that the image data processing part 32 does not have the temporary storage part 321. In this case, the control part 31 applies selection result information indicating the selected result of the gamma table to the image data processing part 32. The image data processing part 32 reads out a gamma table corresponding to the provided selection result information from the storage part 39. As a result, the gamma table selected by the control part 31 is used in the image data processing part 32.

### Embodiment 2

A hardware configuration of a display apparatus 1 according to the present embodiment is similar to the hardware configuration of the display apparatus 1 according to Embodiment 1. Hereinafter, differences from Embodiment 1 will be described, and the other parts corresponding to Embodiment 1 will be denoted by the same reference numerals and will not be described.

The present embodiment and Embodiment 1 are different from each other in terms of the second gamma table.

First, the blue gamma table will be described.

A manufacturer determines the input gradation value V[i] which becomes a reference. In the present embodiment, the input gradation value V[192] is used as a reference. In addition, the manufacturer determines a prescribed upper limit ratio A2. In the present embodiment, the prescribed upper limit ratio A2 is set to be 80%.

The second output gradation value B[i] is obtained by setting the result calculated using the following Equations (6-1) and (6-2) to be an integer value. Hereinafter, Equations (6-1) and (6-2) are collectively referred to as Equation (6). Equation (6) is an alternative to Equation (2) in Embodiment 1. A prescribed ratio A3[i] is a constant as described below.

B[192]=W[192]×(A2/100) (6-1)

B[i]=W[i]×(A3[i]/100) (6-2)

Herein, the prescribed ratio A3[i] is any value satisfying a relationship of 0<A3[i]≦A2 (unit is [%]). As the prescribed ratio A3[i] is decreased, the blue light is weakened.

The manufacturer appropriately sets the prescribed ratio A3[i] other than i=192, so that both of reducing the intensity of the blue light and suppressing the deterioration in the image quality are satisfied. For example, the manufacturer sets the prescribed ratio A3[i] relating to a range of 193≦i≦255 to be a constant value of less than the prescribed upper limit ratio A2. Alternately, the manufacturer sets the prescribed ratio A3[i] relating to the range of 193≦i≦255 so as to decrease gradually from the prescribed upper limit ratio A3 according to an increase in the input gradation value V[i]. The reason is that, as the value of the input gradation value V[i] of the blue color is increased, it is necessary to greatly reduce the blue light.

When appropriately setting the prescribed ratio A3 [i] and then using Equation (6), the second output gradation value B[i] is calculated, and therefore the blue gamma table is obtained.

After calculating the second output gradation value B[i], the manufacturer obtains the CT characteristic curves when performing the blue-light blocking only by simply weakening the blue light (hereinafter, referred to as simple CT characteristic curves). The simple CT characteristic curves correspond to the CT characteristic curves illustrated in FIG. 3 of Embodiment 1. Therefore, the chromaticity x[i] and y[i] of the simple CT characteristic curves are obtained by substituting Equations (3-7) to (3-9) and (6) into Equation (4).

The simple CT characteristic curves illustrated in the present embodiment are smooth within the range in which the input gradation value V[i] is “0” to “32” and “192” to “255,” while within the range in which the input gradation value V[i] is “32” to “192,” the vicinity of the inflection points is steep, not smooth.

Herein, the chromaticity x[192] and y[192] in the simple CT characteristic curves are set to be constants x2 and y2. In addition, a case in which the chromaticity x[32] and y[32] and the chromaticity x[255] and y[255] in the simple CT characteristic curves have a relationship of x[32]=x[255]=0.282 and y[32]=Y[255]=0.288 will be exemplified.

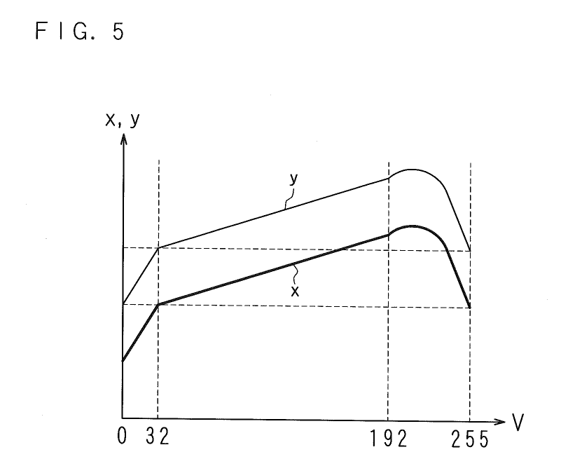

FIG. 5 is a graph illustrating the CT characteristic curves in the case of performing the blue-light blocking in the display apparatus 1 according to Embodiment 2 of the present invention. FIG. 5 corresponds to FIG. 4 of Embodiment 1. The CT characteristic curves illustrated in FIG. 5 are linearly approximated within the range in which the input gradation values V[i] of each of the RGB three colors are “32” to “192” in the simple CT characteristic curves as described above.

In this case, the chromaticity x[i] and y[i] in a range of 32≦V[i]≦192 are represented by the following Equations (7-1) and (7-2).

x[i]={(x2−0.282)/160}×V[i]−0.2×2+0.338 (7-1)

y[i]={(y2−0.288)/160}×V[i]−0.2×y2+0.418 (7-2)

Hereinafter Equations (7-1) and (7-2) are collectively referred to as Equation (7). If the input gradation value V[32] is substituted into in Equation (7), a relationship of x[32]=0.282 and y[32]=0.288 is obtained.

Next, the red gamma table and the green gamma table will be described.

In the present embodiment, within a range from a first prescribed gradation value or more which is greater than the minimum value of the input gradation value V[i] to a second prescribed graduation value or less which is smaller than the maximum value of the input gradation value V[i], the chromaticity x[i] and y[i] calculated from the input gradation value V[i] and the second output gradation values R[i], G[i] and B[i] follow a prescribed function.

First, the case within the range of less than the first prescribed gradation value and exceeding the second prescribed gradation value will be described.

Within a range of 0≦V[i]<32 and within a range of 192<V[i]≦255, a relationship of R[i]=G[i]=W[i] is obtained. Briefly, each of the second output gradation values R[i] and G[i] within a range of 0≦V[i]<32 and within a range of 192<V[i]≦255 in the red gamma table and the green gamma table is easily obtained by copying the first output gradation value W[i] in the first gamma table.

Next, the case within a range from the first prescribed gradation value or more to the second prescribed gradation value or less will be described.

Within the range of 32≦V[i]≦192, the second output gradation values R[i] and G[i] are calculated so that the chromaticity x[i] and y[i] calculated from the second output gradation values R[i], G[i] and B[i] follow Equation (7). Upon this calculation, since the second output gradation value B[i] and the chromaticity x[i] and y[i] are known, when solving Equations (3), (4) and (7) with respect to the second output gradation values R[i] and G[i], and setting the obtained results to be an integer value, the second output gradation values R[i] and G[i] are obtained.

When executing the gamma-correction processing using the second gamma table obtained as described above, the CT characteristic curves are smooth as illustrated in FIG. 5. Therefore, the second color image is high-quality.

When using the display apparatus 1 as described above, it is possible to obtain an effect similar to that of the display apparatus 1 of Embodiment 1.

However, the second color image in the present embodiment has improved image quality as compared to the second color image in Embodiment 1. The reason is that, the entire input gradation value is divided into three sections, and within the range of each divided section, the CT characteristic curves which are smooth but different from each other are set.

In addition, the second color image in the present embodiment tends to be dark as a whole, as compared to the second color image in Embodiment 1. The reason is that, since the second output gradation value B[i] in the present embodiment is a value of the second output gradation value B[i] or less in Embodiment 1, the second output gradation values R[i] and G[i] in the present embodiment also tend to be a value of the second output gradation values R[i] and G[i] or less in Embodiment 1.

### Embodiment 3

A hardware configuration of a display apparatus 1 according to the present embodiment is similar to the hardware configurations of the display apparatuses 1 according to Embodiments 1 and 2. Hereinafter, differences from Embodiments 1 and 2 will be described, and the other parts corresponding to Embodiments 1 and 2 will be denoted by the same reference numerals and will not be described.

The present embodiment and Embodiments 1 and 2 are different from each other in terms of the second gamma table.

First, the blue gamma table will be described.

The second output gradation value B[i] is obtained by setting the result calculated using the following Equations (8-1) to (8-5) to be an integer value. Hereinafter, Equations (8-1) to (8-5) are collectively referred to as Equation (8). Equation (8) is an alternative to Equation (2) in Embodiment 1 and Equation (6) in Embodiment 2. Each of the prescribed ratios A4, A5, A6 and A7 is any value having a relationship of 0<A4, A5, A6 and A7<100 (unit is [%]).

B[i]=W[i]×(A4/100)s.t.0≦V[i]<32 (8-1)

B[i]=W[i]×(A5/100)s.t.32≦V[i]<64 (8-2)

B[i]=W[i]×(A6/100)s.t.64≦V[i]<128 (8-3)

B[i]=W[i]×(A7/100)s.t.128≦V[i]<192 (8-4)

B[i]=W[i]×(A8/100)s.t.192≦V[i]<255 (8-5)

That is, the entire input gradation value in the present embodiment is divided into five sections, and within the range of each divided section, the second output gradation value B[i] is uniformly reduced to a prescribed ratio of the first output gradation value W[i].

When appropriately setting the prescribed ratios A4, A5, A6 and A7 and then using Equation (8), the second output gradation value B[i] is calculated, and therefore the blue gamma table is obtained.

After calculating the second output gradation value B[i], the manufacturer obtains the simple CT characteristic curves. The chromaticity x[i] and y[i] of the simple CT characteristic curves in the present embodiment are obtained by substituting Equations (3-7) to (3-9), and (8) into Equation (4).

The simple CT characteristic curves exemplified in the present embodiment are smooth within the range in which the input gradation value V[i] is “0” to “32,” but within the range in which the input gradation value V[i] is “32” to “255,” the vicinity of the inflection points is steep, not smooth.

Herein, the chromaticity x[32] and y[32] in the simple CT characteristic curves are set to be constants x3 and y3. Similarly, the chromaticity x[64] and y[64], the chromaticity x[128] and y[128], and the chromaticity x[255] and y[255] in the simple CT characteristic curves are set to be constants x4 and y4, constants x5 and y5, and constants x6 and y6, respectively. Specific numerical examples thereof are that x3=0.266, y3=0.272, x4=0.298, y4=0.302, x5=0.308, y5=0.314, x6=0.282, and y6=0.288.

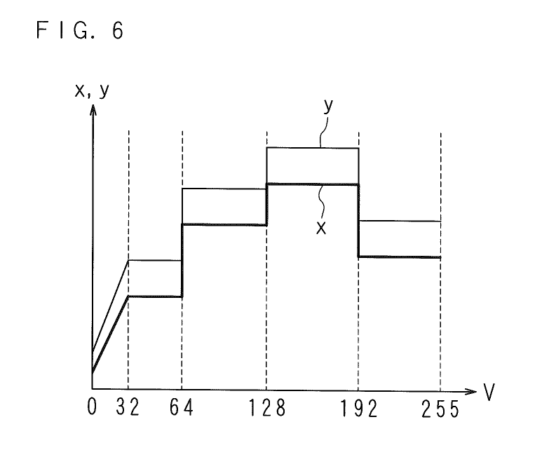

FIG. 6 is a graph illustrating the CT characteristic curves in the case of performing the blue-light blocking in the display apparatus 1 according to Embodiment 3 of the present invention. FIG. 6 corresponds to FIG. 4 in Embodiment 1 and FIG. 5 in Embodiment 2.

The CT characteristic curves illustrated in FIG. 6 are obtained by dividing the input gradation value V[i] into five sections similarly to the case of calculating the second output gradation value B[i], and linearly approximating within each divided range.

In this case, the chromaticity x[i] and y[i] in a range of 32≦V[i]≦255 are represented by the following Equations (9-1) to (9-8). Hereinafter, Equations (9-1) to (9-8) are collectively referred to as Equation (9).

x[i]=x3s.t.32≦V[i]<64 (9-1)

y[i]=y3s.t.32≦V[i]<64 (9-2)

x[i]=x4s.t.64≦V[i]<128 (9-3)

y[i]=y4s.t.64≦V[i]<128 (9-4)

x[i]=x5s.t.128≦V[i]<192 (9-5)

y[i]=y5s.t.128≦V[i]<192 (9-6)

x[i]=x6s.t.192≦V[i]<255 (9-7)

y[i]=y6s.t.192≦V[i]<255 (9-8)

Next, the red gamma table and the green gamma table will be described.

In the present embodiment, within a range from a first prescribed gradation value or more which is greater than the minimum value of the input gradation value V[i] to a second prescribed graduation value or less which is equal to the maximum value of the input gradation value V[i], the chromaticity x[i] and y[i] calculated from the input gradation value V[i] and the second output gradation values R[i], G[i] and B[i] follow a prescribed function for each range in which the input gradation value V[i] is divided into a plurality of sections.

First, the case within the range of less than the first prescribed gradation value will be described.

Each of the second output gradation values R[i] and G[i] within a range of 0≦V[i]<32 is easily obtained by copying the first output gradation value W[i] in the first gamma table.

Next, the case within a range from the first prescribed gradation value or more to the second prescribed gradation value or less will be described.

Within a range of 32≦V[i]≦255, the second output gradation values R[i] and G[i] are calculated so that the chromaticity x[i] and y[i] calculated from the second output gradation values R[i], G[i] and B[i] follow Equation (9). Upon this calculation, since the second output gradation value B[i] and the chromaticity x[i] and y[i] are known, when solving Equations (3), (4) and (9) with respect to the second output gradation values R[i] and G[i], and setting the obtained result to be an integer value, the second output gradation values R[i] and G[i] are obtained.

When executing the gamma-correction processing using the second gamma table obtained as described above, the CT characteristic curves are smooth as illustrated in FIG. 6. Therefore, the second color image is high-quality.

When using the display apparatus 1 as described above, it is possible to obtain an effect similar to that of the display apparatus 1 of Embodiment 1.

However, the second color image in the present embodiment has improved image quality, as compared to the second color images in Embodiments 1 and 2. The reason is that, the input gradation value is divided into five sections, and within each divided range, the CT characteristic curves which are smooth but different from each other are set.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

In addition, as long as having the effects of the present invention, components which are not disclosed in Embodiments 1 to 3 may be included in the display apparatus 1.

Components (technical characteristics) disclosed in each embodiment may be combined with each other, and by combining these components, new technical characteristics may be formed.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

1-5. (canceled)

6. A display apparatus comprising:
a storage part configured to store a plurality of types of image processing data to be used when executing an image processing on a color image in which each color is represented by a gradation value;
a selection part configured to select one type of image processing data from the plurality of types of image processing data stored in the storage part; and
an image processing part configured to execute the image processing using the image processing data selected by the selection part on the color image,
the color image in which the image processing is executed by the image processing part being displayed on the display apparatus,
wherein the storage part stores
first image processing data configured to adjust the gradation values of one color and the other colors, and
second image processing data configured to adjust the gradation value of the one color to be smaller than a gradation value in a case of adjusting using the first image processing data, and adjust the gradation value of other colors so that a chromaticity obtained from the gradation value after adjustment of each of the one color and the other colors satisfies a prescribed condition.

7. The display apparatus according to claim 6,
wherein the prescribed condition includes a condition in which, within a range from a first prescribed gradation value or more which is a minimum value or more of the gradation value before adjustment to a second prescribed gradation value or less which is a maximum value or less of the gradation value before adjustment, the gradation value before adjustment and the chromaticity follow a prescribed function.

8. The display apparatus according to claim 6,
wherein, in relation to the gradation value of the one color, the gradation value after adjustment using the second image processing data is equal to a value obtained by reducing the gradation value after adjustment using the first image processing data in a prescribed procedure.

9. The display apparatus according to claim 6,
wherein each of the first and second image processing data is stored in a lookup table to be used upon a gamma-correction processing.

10. The display apparatus according to claim 6,
wherein the one color is a blue color, and the other colors are a red color and a green color.
